(19) United States
(12) Patent Application Publication
(10) Pub. No.: US 2016/0142454 A1
(43) Pub. Date: May 19, 2016

(54) MULTI-CHANNEL AUDIO ALIGNMENT SCHEMES

(71) Applicant: QUALCOMM Incorporated, San Diego, CA (US)

(72) Inventors: Magesh Hariharan, San Diego, CA (US); Lior Amarilio, Yokneam (IL); Julio Arceo, San Diego, CA (US); Aris Balatsos, Markham (CA); Hans Georg Gruber, San Diego, CA (US)

(21) Appl. No.: 14/541,557

(22) Filed: Nov. 14, 2014

(51) Int. Cl. H04L 29/06; H04R 3/12

(52) U.S. Cl. CPC H04L 65/4069; H04R 3/12

(57) ABSTRACT

Multi-channel audio alignment schemes are disclosed. One aspect of the present disclosure provides for accumulation of audio samples across multiple related audio channels at an audio source. Related audio channels indicate their interrelatedness, and when all the related audio channels have data to transmit, the source releases the data onto the time slots of the Serial Low-power Inter-chip Media Bus (SLIMbus), such that the related audio channels are within a given segment window of the time slot. This accumulation is repeated at the boundary of every segment window. Similarly, accumulation may be performed at the audio sink. Components within the audio sink may only read received data if status signals from all related sinks indicate that predefined thresholds have been reached. By providing such accumulation options, audio fidelity is maintained across multiple audio data channels.

### BACKGROUND

I. Field of the Disclosure

The technology of the disclosure relates generally to the Serial Low-power Inter-chip Media Bus (SLIMbus) specification announced by MIPI® and particularly for managing multiple related audio channels using a SLIMbus.

II. Background

Electronic devices, such as mobile phones and computer tablets, have become common in contemporary society for supporting various everyday uses. These electronic devices each commonly include a microphone and speakers. Typical microphones and speakers used in electronic devices have analog interfaces, requiring dedicated two (2) port wiring to connect each device. However, electronic devices may include multiple audio devices, such as multiple microphones and/or speakers. Thus, it may be desired to allow for a microprocessor or other control device in such electronic devices to be able to communicate audio data to multiple audio devices over a common communications bus. Further, it may also be desired to provide a defined communications protocol for transporting digital data relating to audio channels to different audio devices in an electronic device over a common communications bus.

The MIPI® Alliance has set forth the Serial Low-power Inter-chip Media Bus (SLIMbus™) standard, version 1.01 of which was released to adopters on Dec. 3, 2008. Copies of this standard can be found to members of the MIPI® Alliance at www.mipi.org/specifications/serial-low-power-inter-chip-media-bus-slimbussm-specification. SLIMbus is designed as an interface for audio data in the mobile terminal industry, allowing communication between modems, application processors, and standalone codec chips. SLIMbus is a time division multiplexed (TDM) bus with contiguous time slots carrying samples of a given audio channel. More than one channel can be defined on the bus at the same time as bandwidth permits. SLIMbus has been generally adopted by many within the mobile terminal industry.

When more than one channel is provided in a computing device that uses a SLIMbus, the SLIMbus standard does not address how these data channels can be aligned at the destination side so as to provide optimal audio fidelity. Accordingly, the SLIMbus standard may be improved by providing related channel alignment with corresponding increases in audio fidelity.

### SUMMARY OF THE DISCLOSURE

Aspects disclosed in the detailed description include multi-audio channel alignment schemes. In particular, aspects of the present disclosure provide for accumulation of audio samples across multiple related audio channels at an audio source. Related audio channels indicate their interrelatedness, and when all the related audio channels have data to transmit, the source releases the data onto the time slots of the Serial Low-power Inter-chip Media Bus (SLIMbus), such that the related audio channels are within a given segment window of the time slot. This accumulation is repeated at the boundary of every segment window. Similarly, accumulation may be performed at the audio sink. Components within the audio sink may only read received data if status signals from all related sinks indicate that predefined thresholds have been reached. By providing such accumulation options, audio fidelity is maintained across multiple audio data channels.

In this regard in one aspect, a method of controlling an audio stream is defined. The method comprises providing first data associated with a first audio channel from an audio stream to a first port in an audio service. The method also comprises providing second data associated with a second audio channel from the audio stream to a second port in the audio source. The method further comprises, at the first port, accumulating the first data in a first first in, first out (FIFO) register. The method also comprises, at the second port, accumulating the second data in a second FIFO register and programming the first and second ports to operate at identical channel rates. The method further comprises, at a segment window boundary, draining the first and second FIFO registers, such that equivalent audio samples in the first audio channel and the second audio channel are able to be grouped and placed into a segment window corresponding to the segment window boundary in a time division format.

In another aspect, a method of controlling an audio stream is defined. The method comprises receiving first data associated with a first audio channel from an audio bus at a first port in an audio sink. The method also comprises receiving second data associated with a second audio channel from the audio bus at a second port in the audio sink. The method further comprises, at the first port, accumulating the first data in a first FIFO register and at the second port, accumulating the second data in a second FIFO register. The method further comprises programming the first and second ports to operate at identical channel rates and comparing a first count at the first FIFO register to a first predefined threshold. The method also comprises setting a first ready signal if the first count exceeds the first predefined threshold. The method further comprises comparing a second count at the second FIFO register to a second predefined threshold. The method also comprises setting a second ready signal if the second count exceeds the second predefined threshold and allowing contents of the first and second FIFO registers to be read if the first ready signal and the second ready signal are set.

In another aspect, an audio source is defined. The audio source comprises an interface configured to be coupled to a bus, a first port comprising a first FIFO register, and a second port comprising a second FIFO register. The audio source also comprises a control system operatively coupled to the first port and the second port. The control system is configured to provide first data associated with a first audio channel from an audio stream to the first port and provide second data associated with a second audio channel from the audio stream to the second port. The control system is also configured to instruct the first port to accumulate the first data the first FIFO register and instruct the second port to accumulate the second data in the second FIFO register. The control system is further configured to program the first and second ports to operate at identical channel rates and, at a segment window boundary, drain the first and second FIFO registers, such that equivalent audio samples in the first audio channel and the second audio channel are able to be grouped and placed into a segment window corresponding to the segment window boundary in a time division format.

In another aspect, an audio sink is defined. The audio sink comprises an interface configured to be coupled to a bus. The audio sink also comprises a first port comprising a first FIFO register, the first port configured to receive first data associated with a first audio channel from the interface. The audio sink also comprises a second port comprising a second FIFO register, the second port configured to receive second data associated with a second audio channel from the interface. The audio sink further comprises a control system operatively coupled to the first port and the second port. The control system is configured to instruct the first port to accumulate the first data in the first FIFO register and instruct the second port to accumulate the second data in the second FIFO register. The control system is also configured to program the first and second ports to operate at identical channel rates. The control system is further configured to receive a first ready signal if a first count from the first FIFO register exceeds a first predefined threshold and receive a second ready signal if a second count from the second FIFO register exceeds a second predefined threshold. The control system is further configured to allow contents of the first and second FIFO registers to be read if the first ready signal and the second ready signal are received.

### BRIEF DESCRIPTION OF THE FIGURES

FIG. 1 is a block diagram of an exemplary mobile terminal with audio elements;

FIG. 2 is a block diagram of an exemplary mobile terminal driving an external audio system;

FIG. 3 is a simplified diagram of a SLIMbus with associated components;

FIG. 4 is a simplified block diagram of ports within SLIMbus components and a SLIMbus extending between two components;

FIG. 5 is a simplified timing diagram of how related audio channels are provided within a single segment window on the SLIMbus;

FIG. 6 is a simplified block diagram of the elements within an audio source component according to an exemplary aspect of the present disclosure;

FIG. 7 is a simplified block diagram of the elements within an audio sink component according to an exemplary aspect of the present disclosure;

FIG. 8 is a flow chart of the process for the source accumulating and transmitting related channels; and

FIG. 9 is a flow chart of the process for the sink receiving and accumulating related channels.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include multi-channel audio alignment schemes. In particular, aspects of the present disclosure provide for accumulation of audio samples across multiple related audio channels at an audio source. Related audio channels indicate their interrelatedness, and when all the related audio channels have data to transmit, the source releases the data onto the time slots of the SLIMbus, such that the related audio channels are within a given segment window of the time slot. This accumulation is repeated at the boundary of every segment window. Similarly, accumulation may be performed at the audio sink. Components within the audio sink may only read received data if status signals from all related sinks indicate that predefined thresholds have been reached. By providing such accumulation options, audio fidelity is maintained across multiple audio data channels.

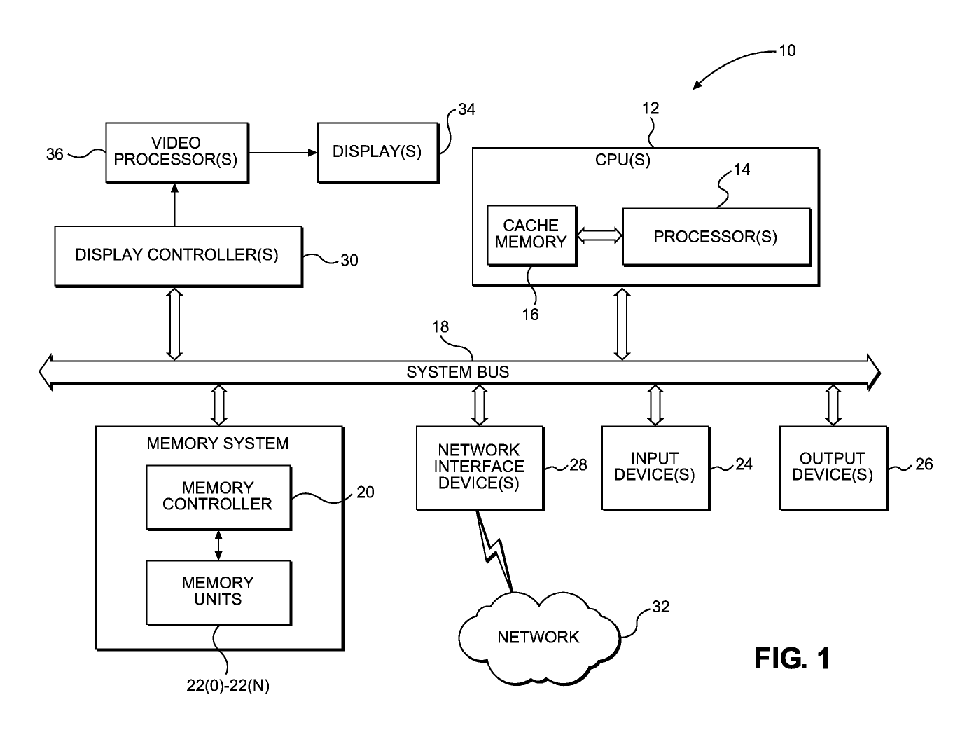

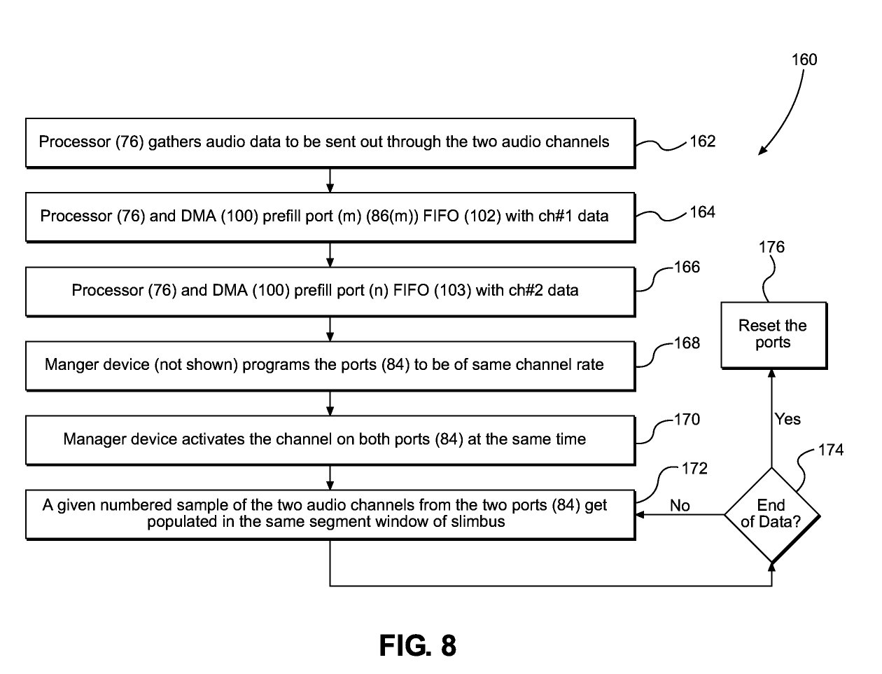

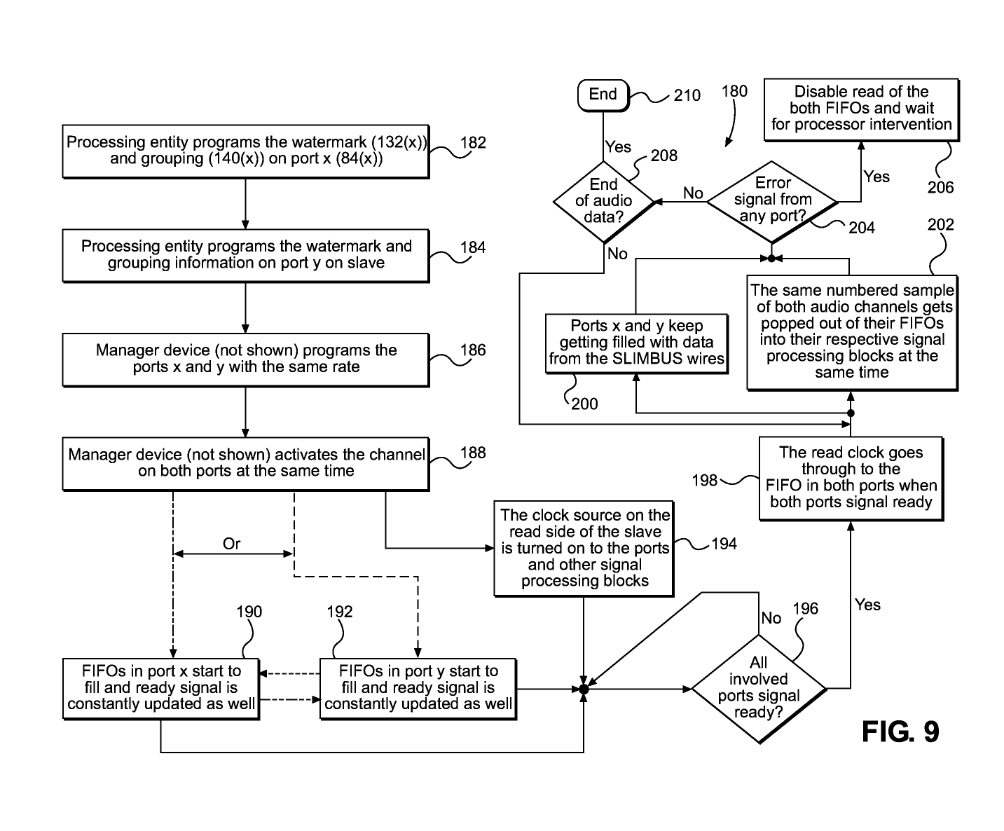

Before addressing exemplary methods and processes associated with the present disclosure, an overview of the hardware elements in which such methods and processes may be implemented are provided with reference to FIGS. 1-7. Exemplary processes are provided with reference to FIGS. 8 and 9.

In this regard, FIG. 1 illustrates an example of a mobile terminal 10. While a mobile terminal 10 is specifically illustrated, other processor-based systems that employ a time division multiplexed bus for multi-channel audio may also benefit from aspects of the present disclosure. In this example, the mobile terminal 10 includes one or more central processing units (CPUs) 12, each including one or more processors 14. The processors 14 may include one or more applications processors that handle audio processing. The CPU(s) 12 may have cache memory 16 coupled to the processor(s) 14 for rapid access to temporarily stored data. The CPU(s) 12 is coupled to a system bus 18 and can intercouple devices included in the mobile terminal 10. As is well known, the CPU(s) 12 communicates with these other devices by exchanging address, control, and data information over the system bus 18. For example, the CPU(s) 12 can communicate bus transaction requests to a memory controller 20 to access memory units 22(0)-22(N). Although not illustrated in FIG. 1, multiple system buses 18 could be provided, wherein each system bus 18 constitutes a different fabric. Likewise, in an exemplary aspect, one of the system buses 18 may be a Serial Low-power Inter-chip Media Bus (SLIMbus) for audio. In another exemplary aspect, a SLIMbus may be present for one or more input devices (e.g., a microphone), and for one or more output devices (e.g., a speaker).

Other devices can be connected to the system bus 18. As illustrated in FIG. 1, these devices can include a memory system that includes memory controller 20 and memory units 22(0)-22(N), one or more input devices 24, one or more output devices 26, one or more network interface devices 28, and one or more display controllers 30, as examples. The input device(s) 24 can include any type of input device, including but not limited to input keys, switches, microphones, voice processors, etc. In the event that an input device 24 is a microphone, it may be connected to a SLIMbus. The output device(s) 26 can include any type of output device, including but not limited to audio, such as speakers, video, other visual indicators, etc. In the event that an output device 26 is a speaker, it may be connected to a SLIMbus. The network interface device(s) 28 can be any devices configured to allow exchange of data to and from a network 32. The network 32 can be any type of network, including but not limited to a wired or wireless network, a private or public network, a local area network (LAN), a wide area network (WAN), a wireless local area network (WLAN), and the Internet. The network interface device(s) 28 can be configured to support any type of communications protocol desired.

The CPU(s) 12 may also be configured to access the display controller(s) 30 over the system bus 18 to control information sent to one or more displays 34. The display controller(s) 30 sends information to the display(s) 34 to be displayed via one or more video processors 36, which process the information to be displayed into a format suitable for the display(s) 34. The display(s) 34 can include any type of display, including but not limited to a cathode ray tube (CRT), a light emitting diode (LED) display, a liquid crystal display (LCD), a plasma display, etc.

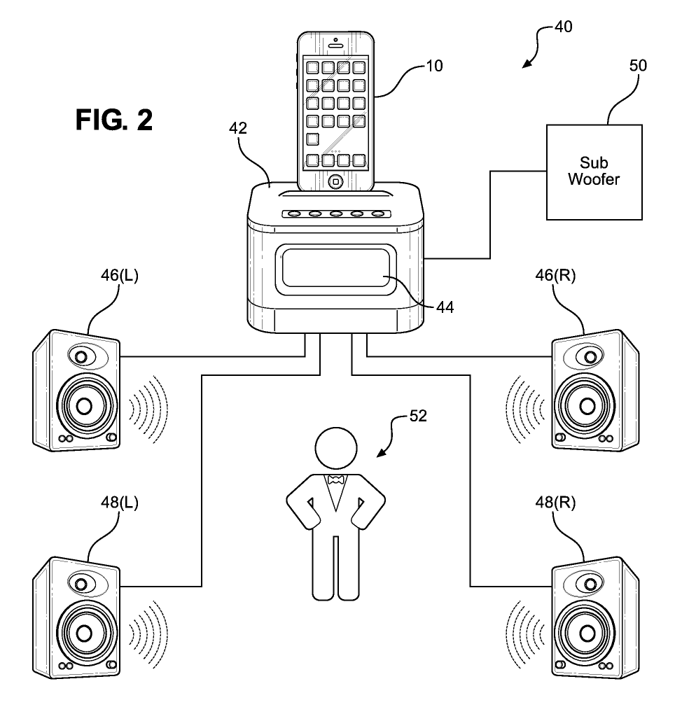

While the mobile terminal 10 may include plural speakers and/or plural microphones coupled by a SLIMbus, the mobile terminal 10 may be coupled to an external sound system such as through a docking station (or wirelessly). In this regard, FIG. 2 illustrates a 5.1 channel surround sound system 40 with mobile terminal 10 associated with a docking station 42. The docking station 42 may include a center speaker 44 and couple to front speakers 46(L) and 46(R) as well as rear speakers 48(L) and 48(R) and a sub-woofer 50. As is well understood, each speaker 44, 46(L), 46(R), 48(L), and 48(R), and sub-woofer 50 may have a separate audio channel. When the output of the speakers and sub-woofer 50 44, 46(L), 46(R), 48(L), and 48(R) is properly aligned, a listener 52 may experience high audio fidelity.

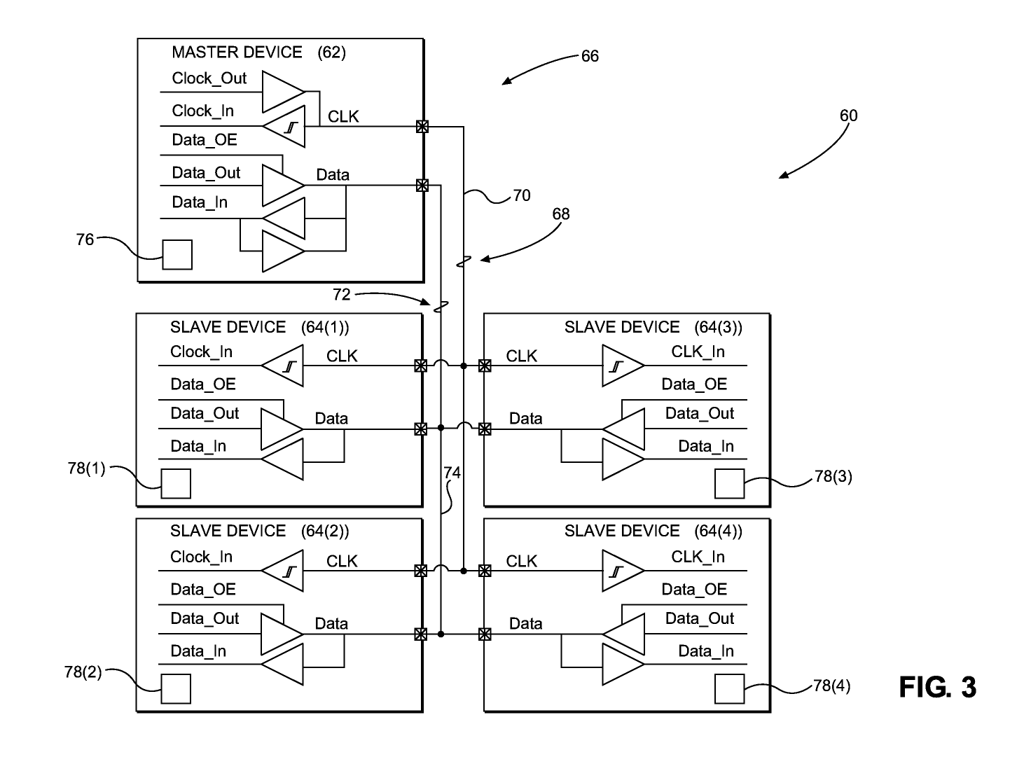

Regardless of whether the audio components are internal to the mobile terminal 10 (or other processor based device) or an external system, the mobile terminal 10 (or other processor based device) may include a SLIMbus to move audio data between audio components such as modems, codecs, and/or applications processors. In this regard, a simplified audio system 60 is illustrated in FIG. 3. Simplified audio system 60 may include a master 62 (sometimes referred to as a master device, but since “device” sometimes has specific connotations, primarily referenced as simply “master” hereinafter) and slave devices 64(1)-64(4) communicatively coupled to a SLIMbus communications bus 66 as components. In an exemplary aspect, the slave devices 64(1)-64(4) may be microphones, speakers, or other audio devices. The master 62 may be an application processor, a codec, or a modem, and communicates with the slave devices 64(1)-64(4) using two signals: a clock signal 68 communicated over a common clock wire 70, and a data signal 72 communicated on a common data wire 74. While only four slave devices 64(1)-64(4) are illustrated in FIG. 3, it should be appreciated that more or fewer components may be coupled to the SLIMbus communications bus 66. It should be appreciated that the master 62 may have a control system (CS) 76 associated therewith, which may be a hardware implemented processor with associated software stored in memory associated with the processor. In an exemplary aspect, the control system 76 is part of the system on a chip (SoC) of the master 62. In an alternate exemplary aspect, the control system 76 may be associated with the CPU 12 of the mobile terminal 10. In further exemplary aspects, the slave devices 64(1)-64(4) each have a respective slave control system 78(1)-78(4).

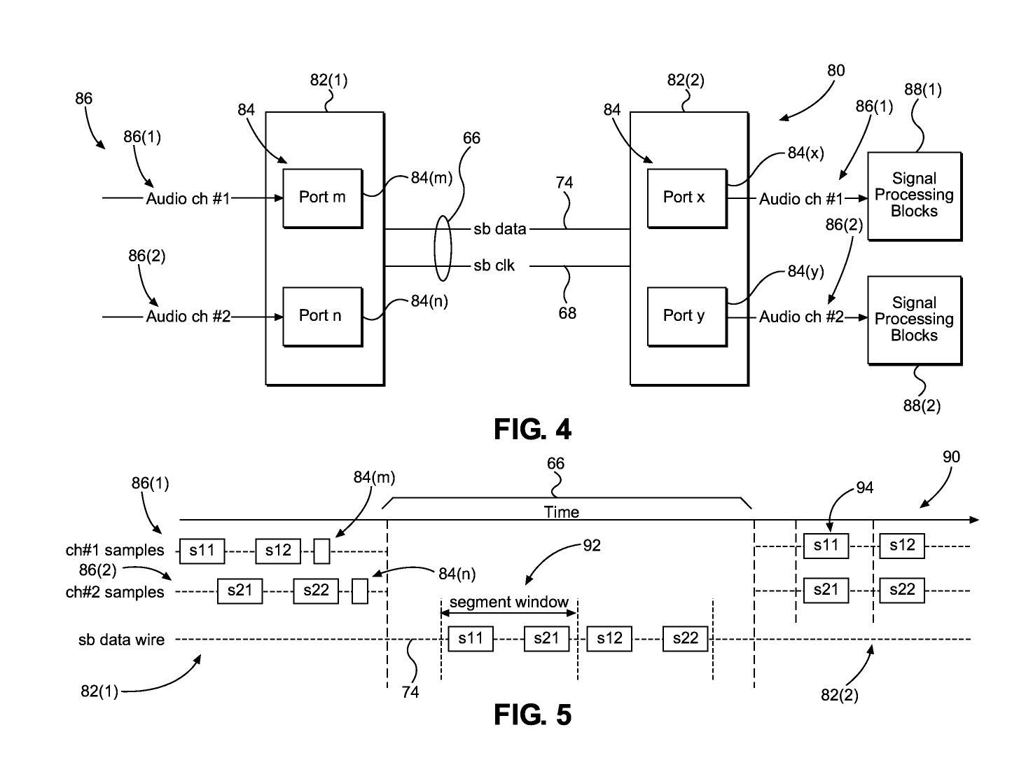

It should be appreciated that each component within the simplified audio system 60 may include multiple ports, each of which may be assigned to different audio channels. Exemplary aspects of this arrangement are illustrated in FIG. 4. In particular, an audio system 80 may include a first component 82(1) and a second component 82(2). First component 82(1) may include plural ports 84, of which 84(m) and 84(n) are illustrated. Similarly, second component 82(2) may include plural ports 84, of which 84(x) and 84(y) are illustrated. Ports 84 receive audio channels 86. In particular, port 84(m) receives first audio channel 86(1) and port 84(n) receives second audio channel 86(2). A serializer (not illustrated) assembles the audio data and places the audio data on the data wire 74. The second component 82(2) uses a deserializer (not illustrated) to extract the data and pass the data to an appropriate port 84. In this example, the data for first audio channel 86(1) is passed to port 84(x) and the data for second audio channel 86(2) is passed to port 84(y). The ports 84 pass the separated audio channels 86(1) and 86(2) to appropriate signal processing blocks 88(1) and 88(2).

Exemplary aspects of the present disclosure provide for accumulating audio data for related audio channels 86 and placing the corresponding samples for the respective related audio channels 86 into a segment window within the TDM signal on the common data wire 74. In this regard, FIG. 5 provides an illustration of a signal flow 90 where channel samples s11 and s12 are sampled out of the first audio channel 86(1) and channel samples s21 and s22 are sampled out of the second audio channel 86(2). The samples from the same general sampling point are accumulated and placed onto the common data wire 74 in the same segment window 92. The accumulation is done at every segment window boundary. The second component 82(2) serializes the data on the common data wire 74 and reassembles the samples. The reassembled samples 94 are aligned at the receiver.

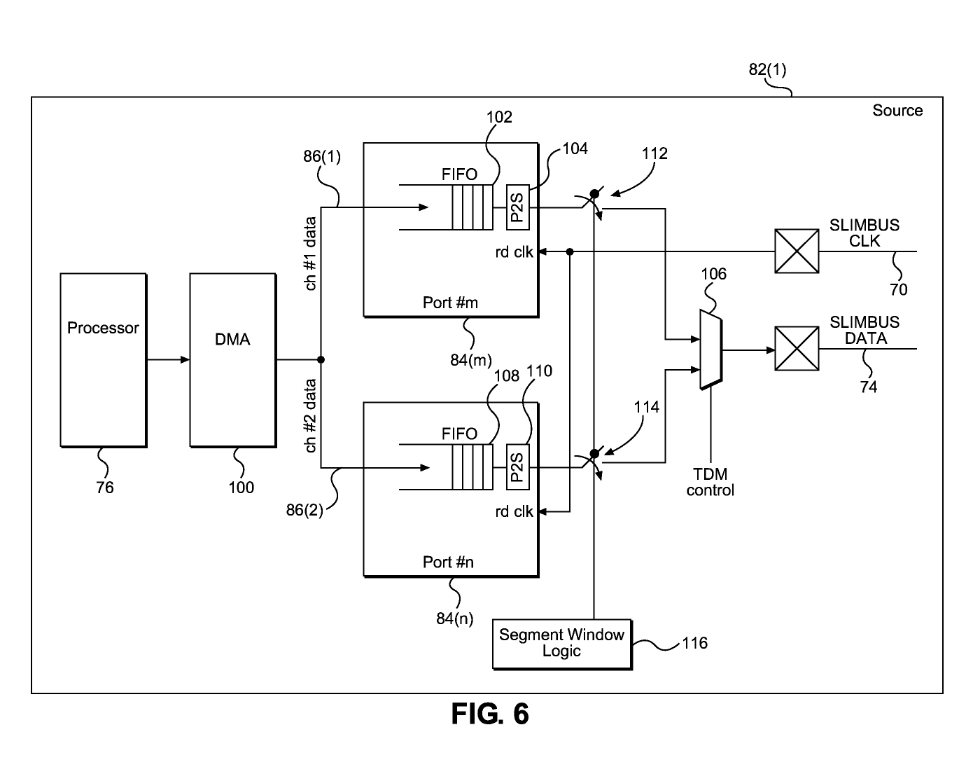

To get the samples aligned at the source, first in, first out (FIFO) registers may be used at each port. FIG. 6 provides a block diagram of the FIFO registers within a source. In this example, the source is first component 82(1) (and may also be the master 62). The first component 82(1) includes a control system, which may be CS 76. While illustrated as a processor in FIG. 6, it should be appreciated that the processor may be replaced with some other signal processing entity and still be the CS 76. The CS 76 communicates with a direct memory access (DMA) module 100. While illustrated as a DMA, it should be appreciated that some other data fetch entity may be used. The DMA module 100 generates the first audio channel 86(1) and second audio channel 86(2). The first audio channel 86(1) is provided to a FIFO 102 at port 84(m). A serializer (Parallel to Serial (P2S)) 104 takes the output of the FIFO 102 and passes the serialized signal to a multiplexer (MUX) 106. Similarly, the second audio channel 86(2) is provided to a FIFO 108 at port 84(n). A serializer 110 takes the output of the FIFO 108 and passes the serialized signal to the MUX 106. Clock signals from the clock wire 70 are provided as needed, or desired, to the ports 84. A TDM control signal controls the MUX 106 to put the respective sample onto the data wire 74. Signals are passed from the ports 84 to the MUX 106 through switches 112, 114 controlled by segment window logic 116. In use, the FIFOs 102, 108 collect (or accumulate) data for the respective audio channels 86 and set a flag or status indicator when a predetermined amount of data has been accumulated. Based on when all the related channels have indicated sufficient data accumulation, the segment window logic 116 releases the data to the MUX 106. In this fashion, data for related samples of the audio channels 86 end up in the same segment window on the data wire 74. Thus, the accumulation provides sample alignment at each segment window after initialization. This alignment helps improve audio fidelity.

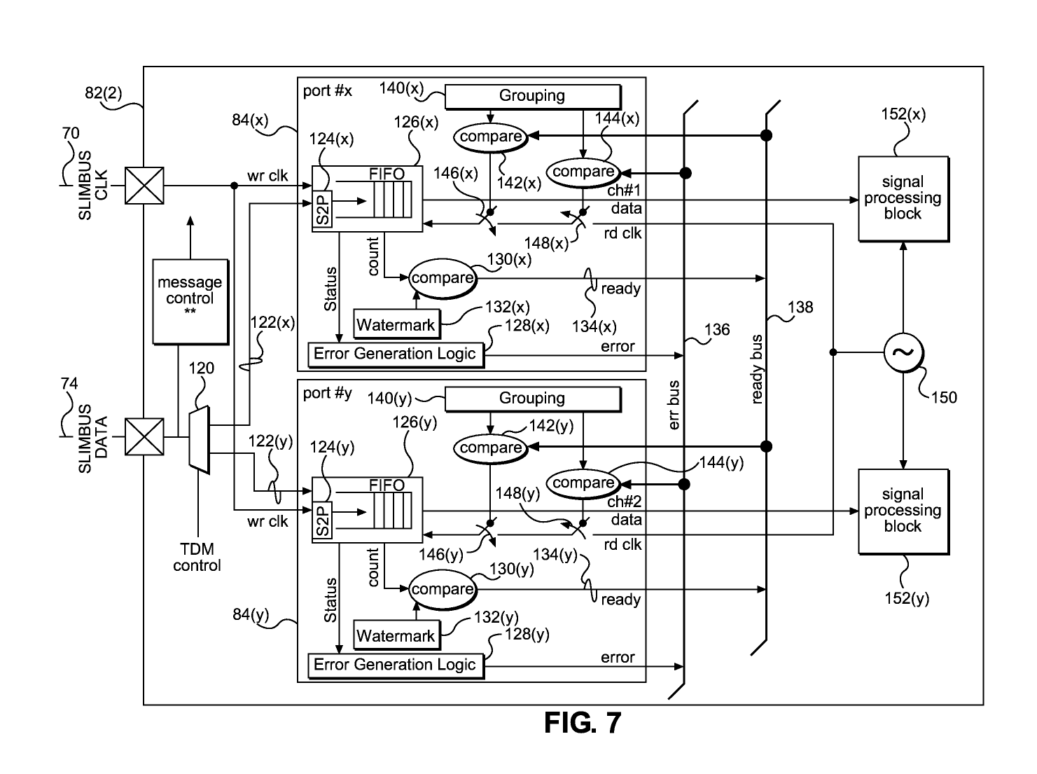

On the receive side, both sample and phase alignment may be desirable to help improve audio fidelity. The structure of such receive side components is provided with reference to FIG. 7. Audio data is received from the data wire 74 at a demultiplexer (DEMUX) 120, which splits the received signal and provides the split signals 122(x) and 122(y) to respective ports 84(x), 84(y). The ports 84 also receive a clock signal 68 from the clock wire 70. The port 84(x) receives the split signal 122(x) at a deserializer (serial to parallel (S2P)) 124(x) associated with a FIFO 126(x). The FIFO 126(x) provides a status message to error generation logic 128(x) and a count to a comparator 130(x). The comparator 130(x) compares the count to a watermark (or other predefined threshold) 132(x) and outputs a ready signal 134(x) based on the comparison (i.e., if the count exceeds the watermark 132(x), then the ready signal 134 is enabled). The error generation logic 128(x) selectively provides an error signal to an error bus 136. The ready signal 134(x) is provided to a ready bus 138.

With continued reference to FIG. 7, exemplary aspects of the present disclosure perform error handling by evaluating the information on the error bus 136 to see if any of the channels of the multi-channel group has an error condition, such as an underflow or overflow condition. If there is an error condition, an exemplary aspect of the present disclosure halts the channel and substitutes null data until the stream is recovered or other corrective action is taken. When corrective action is taken, the stream is restored or recovered as a group.

With continued reference to FIG. 7, the port 84(x) also includes a grouping register 140(x) that sets a status for first comparator 142(x) and second comparator 144(x). The first comparator 142(x) receives signals from the ready bus 138. The second comparator 144(x) receives signals from the error bus 136. Based the comparison of the comparators 142(x), 144(x), switches 146(x), 148(x) are opened or closed to provide a clock signal from a clock 150 to the FIFO 126(x). Based on whether the clock signal is provided to the FIFO 126(x), data is pulled from the FIFO 126(x) to a signal processing block 152(x) for further processing (e.g., passing to a speaker). Clock signals from the clock 150 are also passed to signal processing blocks 152(x) and 152(y). By clocking the signal processing blocks 152(x) and 152(y) with the same clock signal used with the FIFO 126(x) and FIFO 126(y), sample alignment is preserved and audio fidelity is improved.

With continued reference to FIG. 7, port 84(y) has similar elements performing similar functions, albeit designated with a (y). It should be appreciated that the values of the watermark 132 and the information in the grouping register 140 may be programmed by message control or a programming entity as needed or desired.

Against this backdrop of structure, an exemplary process 160 is provided illustrating how related ports at the first component 82(1) are linked. As illustrated, first component 82(1) is a source component. The process 160 begins with the control system 76 gathering audio data to be sent out through the two (or more) audio channels (block 162). The control system 76 and the DMA 100 prefill the FIFO 102 of port(m) with first channel audio data (block 164). The control system 76 and the DMA 100 then prefill the FIFO 108 of port(n) with second channel audio data (block 166). A manager device (not shown) programs the ports 84 to be of the same channel rate (e.g., 48 kHz) (block 168).

With continued reference to FIG. 8, the manager device activates the channel on both ports 84 at the same time (block 170). A given numbered sample of the two audio channels from the two ports 84 get populated in the same segment window (block 172). The manager determines if this is the end of the data (block 174), with the process repeating as noted or ending and resetting the ports (block 176) if block 174 is answered affirmatively.

FIG. 9 illustrates a process 180 that illustrates an exemplary technique to link the channels on the receive side. That is second component 82(2) is a sink component. In this regard, the process 180 begins with the processor programming the watermark 132(x) and the grouping register 140(x) for the port(x) (block 182). The processor programs with watermark 132(y) and the grouping register 140(y) for the port(y) (block 184). Note that the processor may be in the second component 82(2) or may be in the first component 82(1) and the programming may be effectuated by messages sent across the data wire 74.

With continues reference to FIG. 9, a manager device (not shown) may programs the ports 84(x) and 84(y) with the same channel rate (block 186). The manager device activates the channel on both ports at the same time (block 188). A variety of things may happen. In a first instance, the FIFO 126(x) starts to fill and the ready signal 134(x) is constantly updated as well (block 190). The ready signal 134(x) is passed through the ready bus 138 to the port 84(y). In a second instance, the FIFO 126(y) starts to fill and the ready signal 134(y) is constantly updated as well (block 192). The ready signal 134(y) is passed through the ready bus 138 to the port 84(x). At the same time, the clock 150 is turned on and provided to the ports 84(x) and 84(y) and other signal processing blocks 152(x) and 152(y) (block 194). Once all involved ports signal ready (block 196), the read clock goes through the FIFO 126(x) and 126(y) when both ports 84(x) and 84(y) signal ready (block 198).

With continued reference to FIG. 9, the ports 84(x) and 84(y) continue to get filled with data from the data wire 74 (block 200) and the same numbered sample of both audio channels is pulled from the FIFO 126(x) and 126(y) to the respective signal processing blocks 152(x) and 152(y) at the same time (block 202). The controller checks to see if there is an error signal from any port (block 204). If there is an error, the controller disables the read of both FIFO 126(x) and 126(y) and waits for processor intervention (block 206). If there is no error at block 204, then the controller checks to see if there is an end of the audio data (block 208). If there is an end, the process 180 ends (block 210). Otherwise, the process 180 repeats as indicated.

As alluded to above, the multi-channel audio alignment schemes according to aspects disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player. While any such device may benefit from aspects of the present disclosure, the present disclosure is particularly well suited for use with devices that operate according to the SLIMbus protocol.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method of controlling an audio stream, comprising:
providing first data associated with a first audio channel from an audio stream to a first port in an audio source;
providing second data associated with a second audio channel from the audio stream to a second port in the audio source;
at the first port, accumulating the first data in a first first in, first out (FIFO) register;
at the second port, accumulating the second data in a second FIFO register;
programming the first and second ports to operate at identical channel rates; and
at a segment window boundary, draining the first and second FIFO registers, such that equivalent audio samples in the first audio channel and the second audio channel are able to be grouped and placed into a segment window corresponding to the segment window boundary in a time division format.

2. The method of claim 1, further comprising grouping and placing the equivalent audio samples into the segment window corresponding to the segment window boundary.

3. The method of claim 1, further comprising identifying the first port and the second port as related.

4. The method of claim 2, wherein placing the equivalent audio samples into the segment window comprises transmitting the equivalent audio samples across a bus to one or more audio sinks.

5. The method of claim 4, wherein the bus comprises a Serial Low-power Inter-chip Media Bus (SLIMbus).

6. The method of claim 4, wherein the identical channel rates are slower than an allocated bus bandwidth on the bus.

7. The method of claim 6, wherein the identical channel rates comprise 44.1 kbps and the allocated bus bandwidth comprises 48 kHz.

8. A method of controlling an audio stream, comprising:
receiving first data associated with a first audio channel from an audio bus at a first port in an audio sink;
receiving second data associated with a second audio channel from the audio bus at a second port in the audio sink;
at the first port, accumulating the first data in a first first in, first out (FIFO) register;
at the second port, accumulating the second data in a second FIFO register;
programming the first and second ports to operate at identical channel rates;
comparing a first count at the first FIFO register to a first predefined threshold;
setting a first ready signal if the first count exceeds the first predefined threshold;
comparing a second count at the second FIFO register to a second predefined threshold;
setting a second ready signal if the second count exceeds the second predefined threshold; and
allowing contents of the first and second FIFO registers to be read if the first ready signal and the second ready signal are set.

9. The method of claim 8, wherein the first predefined threshold is identical to the second predefined threshold.

10. The method of claim 8, further comprising programming the first predefined threshold.

11. The method of claim 8, further comprising indicating that the first port is related to the second port.

12. The method of claim 8, further comprising generating an error signal at the first FIFO register.

13. The method of claim 12, further comprising disabling reading from the first and second FIFO registers after generating the error signal.

14. The method of claim 12, wherein the audio bus comprises a Serial Low-power Inter-chip Media Bus (SLIMbus).

15. The method of claim 12, wherein the identical channel rates are slower than an allocated bus bandwidth on the audio bus.

16. The method of claim 15, wherein the identical channel rates comprise 44.1 kbps and the allocated bus bandwidth comprises 48 kHz.

17. An audio source comprising:
an interface configured to be coupled to a bus;
a first port comprising a first first in, first out (FIFO) register;
a second port comprising a second FIFO register; and
a control system operatively coupled to the first port and the second port, the control system configured to:
provide first data associated with a first audio channel from an audio stream to the first port;
provide second data associated with a second audio channel from the audio stream to the second port;
instruct the first port to accumulate the first data in the first FIFO register;
instruct the second port to accumulate the second data in the second FIFO register;
program the first and second ports to operate at identical channel rates; and
at a segment window boundary, drain the first and second FIFO registers, such that equivalent audio samples in the first audio channel and the second audio channel are able to be grouped and placed into a segment window corresponding to the segment window boundary in a time division format.

18. The audio source of claim 17, wherein the control system is further configured to identify the first and second ports as related.

19. The audio source of claim 17, wherein the interface comprises a Serial Low-power Inter-chip Media Bus (SLIMbus) interface.

20. The audio source of claim 17, further comprising a multiplexer (MUX) coupled to the first port and the second port and the interface.

21. The audio source of claim 20, wherein the MUX is configured to receive a time division multiplexing control signal.

22. The audio source of claim 20, further comprising:
a first switch between the first port and the MUX, wherein the first switch operates based on the segment boundary; and
a second switch between the second port and the MUX, wherein the second switch operates based on the segment boundary.

23. An audio sink comprising:
an interface configured to be coupled to a bus;
a first port comprising a first first in, first out (FIFO) register, the first port configured to receive first data associated with a first audio channel from the interface;
a second port comprising a second FIFO register, the second port configured to receive second data associated with a second audio channel from the interface; and
a control system operatively coupled to the first port and the second port, the control system configured to:
instruct the first port to accumulate the first data in the first FIFO register;
instruct the second port to accumulate the second data in the second FIFO register;
program the first and second ports to operate at identical channel rates;
receive a first ready signal if a first count from the first FIFO register exceeds a first predefined threshold;
receive a second ready signal if a second count from the second FIFO register exceeds a second predefined threshold; and
allow contents of the first and second FIFO registers to be read if the first ready signal and the second ready signal are received.
